(19) United States
(12) Patent Application Publication
(10) Pub. No.: US 2018/0039114 A1
(43) Pub. Date: Feb. 8, 2018

(54) LIQUID CRYSTAL DISPLAY PANEL AND DRIVE METHOD THEREOF

(71) Applicant: Shenzhen China Star Optoelectronics Technology Co., Ltd., Shenzhen City (CN)

(72) Inventor: Xiangyang XU, Shenzhen City (CN)

(73) Assignee: Shenzhen China Star Optoelectronics TechnologyCo., Ltd., Shenzhen City (CN)

(21) Appl. No.: 15/114,852

(22) PCT Filed: May 26, 2016
(86) PCT No.: PCT/CN2016/083562

§ 371 Date: Jul. 28, 2016

(30) Foreign Application Priority Data
Jan. 13, 2016 (CN) 201610023761.8

(51) Int. Cl. G02F 1/1362; G09G 3/20; G02F 1/1343; G09G 3/36

(52) U.S. Cl. CPC G02F 1/1362; G09G 3/36; G09G 3/2074; G02F 1/134336; G02F 1/136286; G09G 2300/0452

(57) ABSTRACT

The present invention provides a liquid crystal display panel and a drive method thereof. Both the 4jth gate scan line and the 4j−3 gate scan line are set to be odd frame gate scan lines, and both the 4j-1th gate scan line and the 4j−2 gate scan line are set to be even frame gate scan lines, and all the first red sub pixel (R1), the first green sub pixel (G1) and the first blue sub pixel (B1) are electrically coupled to the odd frame gate scan line, and all the second red sub pixel (R2), the second green sub pixel (G2) and the second blue sub pixel (B2) are electrically coupled to the even frame gate scan line, and the odd frame gate scan lines and the even frame gate scan lines respectively perform the odd frame scan and the even frame scan.

### FIELD OF THE INVENTION

The present invention relates to a display technology field, and more particularly to a Liquid crystal display panel and a drive method thereof.

### BACKGROUND OF THE INVENTION

The LCD (Liquid Crystal Display) possesses many advantages of being ultra thin, power saved and radiation free. It has been widely utilized in, such as LCD TVs, mobile phones, Personal Digital Assistant (PDA), digital cameras, laptop screens or notebook screens, and dominates the flat panel display field.

Most of the liquid crystal displays on the present market are backlight type liquid crystal displays, which comprise a liquid crystal display panel and a backlight module. The working principle of the liquid crystal display panel is that the Liquid Crystal is injected between the Thin Film Transistor Array Substrate (TFT array substrate) and the Color Filter (CF). The light of backlight module is refracted to generate images by applying driving voltages to the two substrates for controlling the rotations of the liquid crystal molecules.

The liquid crystal display panel comprises a plurality of sub pixels aligned in array. Each pixel is electrically coupled to one thin film transistor (TFT). The Gate of the TFT is coupled to a horizontal gate scan line, and the Drain of the TFT is coupled to a vertical data line, and the Source is coupled to the pixel electrode. The enough voltage is applied to the gate scan line, and all the TFTs electrically coupled to the gate scan line are activated. Thus, the signal voltage on the data line can be written into the pixels to control the transmittances of the liquid crystals and to realize the display result.

Please refer to FIG. 1. The liquid crystal display panel structure having the dual gate according to prior art comprises: a plurality of data lines, which are mutually parallel, sequentially aligned and vertical, a plurality of gate scan lines, which are mutually parallel, sequentially aligned and horizontal and a plurality of sub pixels arranged in array; a data line is located between the sub pixels of two adjacent columns corresponding to the sub pixels of every two adjacent columns, and both the sub pixels of the two adjacent columns are electrically coupled to the data line. For instance, both the sub pixels of the first column and the sub pixels of the second column are electrically coupled to the first data line D1, and both the sub pixels of the third column and the sub pixels of the fourth column are electrically coupled to the second data line D2, and both the sub pixels of the fifth column and the sub pixels of the sixth column are electrically coupled to the third data line D3, and so on. Gate scan lines are respectively located at upper and lower sides of sub pixels of a row corresponding to the sub pixels of each row. For instance, the first gate scan line Gate 1 is located at the upper side of the sub pixels of the first row, and the second gate scan line Gate 2 is located at the lower side of the sub pixels of the first row, and the third gate scan line Gate 3 is located at the upper side of the sub pixels of the second row, and the fourth gate scan line Gate 4 is located at the lower side of the sub pixels of the second row, and the fifth gate scan line Gate 5 is located at the upper side of the sub pixels of the third row, and the sixth gate scan line Gate 6 is located at the lower side of the sub pixels of the third row, and so on. i is set to be a positive integer, and all the sub pixels of the 2i−1th column are electrically coupled to the gate scan line at the upper side of the row where the sub pixels are, and all the sub pixels of the 2ith column are electrically coupled to the gate scan line at the lower side of the row where the sub pixels are. The sub pixels of each row comprise a red sub pixel R, a green sub pixel G and a blue sub pixel B which are sequentially repeated and aligned, and colors of the sub pixels of the same columns are the same. The aforesaid dual gate design can halve the amount of the data lines, and thus can effectively reduce the production cost of the liquid crystal display panel.

Please refer to FIG. 2 with combination of FIG. 1. The drive procedure of the liquid crystal display panel having the dual gate structure according to prior art shown in FIG. 1 is: the gate scan lines sequentially provide the gate scan signal from the first to the last, and the data lines charge the respective sub pixels. The first data line D1 is illustrated. First, the first gate scan line Gate1 provides the gate scan pulse signal, and the first data line D1 supplies the positive data signal to the red sub pixel R of the first row, the first column. Then, the second gate scan line Gate2 provides the gate scan pulse signal, and the first data line D1 supplies the negative data signal to the green sub pixel G of the first row, the second column. And then, the third gate scan line Gate3 provides the gate scan pulse signal, and the first data line D1 supplies the negative data signal to the red sub pixel R of the second row, the first column. And then, the fourth gate scan line Gate4 provides the gate scan pulse signal, and the first data line D1 supplies the positive data signal to the green sub pixel G of the second row, the second column, and so on. When the positive, negative polarity of the data signal outputted to the first data line D1 by the source drive circuit changes (the positive polarity changes to the negative polarity, or the negative polarity changes to the positive polarity), the signal delay phenomenon appears to the data signal loaded on the first data line D1. Thus, it results in that the charge to the corresponding sub pixel is insufficient, and the brightness of the light emitted by the corresponding sub pixel is larger than the ideal brightness. For the first data line D1, the moment of changing the positive, negative polarity of the data signal is at the moment of charging the sub pixels of the second column to lead to that the sub pixels of the second column are too bright to form the bright fringes at the position of the sub pixels of the second column, and so forth. One bright fringe generates at the positions corresponding to the respective data lines on the liquid crystal display panel, and the appearance of the bright fringe will influence the display quality of the display panel to result in the bad experience of the user. Besides, as shown in FIG. 2, the frequency of the inversion signal POL of performing the positive, negative polarity change to the data line is basically ½ of the clock signal CLK, and the positive, negative polarity of the data signal needs to change many times in the display period of one frame of image, it leads to the higher drive power consumption of the liquid crystal display panel.

### SUMMARY OF THE INVENTION

An objective of the present invention is to provide a liquid crystal display panel, which can effectively weaken the data signal delay to ensure the charge results of the respective sub pixels for eliminating the bright fringes in the display procedure of the liquid crystal display panel having the dual gate structure and for reducing the signal inversion frequency and the drive power consumption of the liquid crystal display panel.

Another objective of the present invention is to provide a drive method of a liquid crystal display panel, which can effectively weaken the data signal delay to ensure the charge results of the respective sub pixels for eliminating the bright fringes in the display procedure of the liquid crystal display panel having the dual gate structure and for reducing the signal inversion frequency and the drive power consumption of the liquid crystal display panel.

For realizing the aforesaid objectives, the present invention provides a liquid crystal display panel, comprising: a plurality of data lines, which are mutually parallel, sequentially aligned and vertical, a plurality of gate scan lines, which are mutually parallel, sequentially aligned and horizontal and a plurality of pixel units arranged in array;

each pixel unit comprising a red pixel module, a green pixel module and a blue pixel module which are sequentially repeated and aligned;

the red pixel module comprising a first red sub pixel and a second red sub pixel, and the green pixel module comprising a first green sub pixel and a second green sub pixel, and the blue pixel module comprising a first blue sub pixel and a second blue sub pixel;

wherein a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same;

gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are;

the first gate scan line to the last gate scan line are sequentially aligned from top to bottom, and j is set to be a positive integer, and both the 4jth gate scan line and the 4j−3 gate scan line are odd frame gate scan lines, and both the 4j−1th gate scan line and the 4j−2 gate scan line are even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line;

as driving the liquid crystal display panel, the odd frame scan lines first perform odd frame scan from top to bottom, and after the odd frame scan is accomplished, the even frame scan lines perform even frame scan from top to bottom;

as the odd frame scan or the even frame scan, polarities of data signals on the respective data lines are the same; the polarity of the data signal on the data line as the odd frame scan and polarity of the data signal on the data line as the even frame scan are opposite.

Selectably, as the odd frame scan, an inversion signal controls the polarities of the data signals on the respective data lines to be positive, and as the even frame scan, the inversion signal controls the polarities of the data signals on the respective data lines to be negative.

Selectably, as the odd frame scan, an inversion signal controls the polarities of the data signals on the respective data lines to be negative, and as the even frame scan, the inversion signal controls the polarities of the data signals on the respective data lines to be positive.

Each sub pixel comprises a thin film transistor, and a pixel electrode electrically coupled to the thin film transistor; a gate of the thin film transistor is electrically coupled to the gate scan line corresponded with the sub pixel, and a source is electrically coupled to a data line corresponded with the sub pixel, and a drain is electrically coupled to the pixel electrode.

The present invention further provides a drive method of a liquid crystal display panel, comprising steps of:

step 1, providing a liquid crystal display panel;

the liquid crystal display panel comprising: a plurality of data lines, which are mutually parallel, sequentially aligned and vertical, a plurality of gate scan lines, which are mutually parallel, sequentially aligned and horizontal and a plurality of pixel units arranged in array;

each pixel unit comprising a red pixel module, a green pixel module and a blue pixel module which are sequentially repeated and aligned;

the red pixel module comprising a first red sub pixel and a second red sub pixel, and the green pixel module comprising a first green sub pixel and a second green sub pixel, and the blue pixel module comprising a first blue sub pixel and a second blue sub pixel;

wherein a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same;

gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are;

the first gate scan line to the last gate scan line are sequentially aligned from top to bottom, and j is set to be a positive integer, and both the 4jth gate scan line and the 4j−3 gate scan line are odd frame gate scan lines, and both the 4j−1th gate scan line and the 4j−2 gate scan line are even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line;

step 2, first performing odd frame scan from top to bottom with the odd frame scan lines, and controlling the respective data lines to provide a data signal of a first polarity with an inversion signal to charge the first red sub pixel, the first green sub pixel and the first blue sub pixel;

step 3, performing even frame scan from top to bottom with the even frame scan lines, and controlling the respective data lines to provide the data signal of a second polarity with the inversion signal to charge the second red sub pixel, the second green sub pixel and the second blue sub pixel.

A frequency of the inversion signal is ½ of a frame frequency of the liquid crystal display panel.

Selectably, the first polarity is positive, and the second polarity is negative.

Selectably, the first polarity is negative, and the second polarity is positive.

In the step 2, the odd frame scan is started by providing an odd frame scan trigger signal to the liquid crystal display panel;

in the step 3, the even frame scan is started by providing an even frame scan trigger signal to the liquid crystal display panel.

Each sub pixel comprises a thin film transistor, and a pixel electrode electrically coupled to the thin film transistor; a gate of the thin film transistor is electrically coupled to the gate scan line corresponded with the sub pixel, and a source is electrically coupled to a data line corresponded with the sub pixel, and a drain is electrically coupled to the pixel electrode.

The present invention further provides a drive method of a liquid crystal display panel, comprising steps of:

step 1, providing a liquid crystal display panel;

the liquid crystal display panel comprising: a plurality of data lines, which are mutually parallel, sequentially aligned and vertical, a plurality of gate scan lines, which are mutually parallel, sequentially aligned and horizontal and a plurality of pixel units arranged in array;

each pixel unit comprising a red pixel module, a green pixel module and a blue pixel module which are sequentially repeated and aligned;

the red pixel module comprising a first red sub pixel and a second red sub pixel, and the green pixel module comprising a first green sub pixel and a second green sub pixel, and the blue pixel module comprising a first blue sub pixel and a second blue sub pixel;

wherein a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same;

gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are;

the first gate scan line to the last gate scan line are sequentially aligned from top to bottom, and j is set to be a positive integer, and both the 4jth gate scan line and the 4j−3 gate scan line are odd frame gate scan lines, and both the 4j−1th gate scan line and the 4j−2 gate scan line are even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line;

step 2, first performing odd frame scan from top to bottom with the odd frame scan lines, and controlling the respective data lines to provide a data signal of a first polarity with an inversion signal to charge the first red sub pixel, the first green sub pixel and the first blue sub pixel;

step 3, performing even frame scan from top to bottom with the even frame scan lines, and controlling the respective data lines to provide the data signal of a second polarity with the inversion signal to charge the second red sub pixel, the second green sub pixel and the second blue sub pixel;

wherein each sub pixel comprises a thin film transistor, and a pixel electrode electrically coupled to the thin film transistor; a gate of the thin film transistor is electrically coupled to the gate scan line corresponded with the sub pixel, and a source is electrically coupled to a data line corresponded with the sub pixel, and a drain is electrically coupled to the pixel electrode;

wherein a frequency of the inversion signal is ½ of a frame frequency of the liquid crystal display panel.

The benefits of the present invention are: the present invention provides a liquid crystal display panel and a drive method thereof. Each pixel unit is set to comprise a red pixel module, a green pixel module and a blue pixel module which are sequentially repeated and aligned. The red pixel module comprises a first red sub pixel and a second red sub pixel, and the green pixel module comprises a first green sub pixel and a second green sub pixel, and the blue pixel module comprises a first blue sub pixel and a second blue sub pixel. Both the 4jth gate scan line and the 4j−3 gate scan line are set to be odd frame gate scan lines, and both the 4j−1th gate scan line and the 4j−2 gate scan line are set to be even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line, and the odd frame gate scan lines and the even frame gate scan lines respectively perform the odd frame scan and the even frame scan. The data lines drive the first red sub pixel, the first green sub pixel and the first blue sub pixel as the odd frame scan, and drive the second red sub pixel, the second green sub pixel and the second blue sub pixel as the even frame scan so that the frequency of the inversion signal is decreased to be ½ of the frame frequency of the liquid crystal display panel. In comparison with prior art, the inversion frequency of the positive, negative polarities of the data signal is tremendously reduced. It can effectively weaken the data signal delay to ensure the charge results of the respective sub pixels for eliminating the bright fringes in the display procedure of the liquid crystal display panel having the dual gate structure and for reducing the drive power consumption of the liquid crystal display panel.

### BRIEF DESCRIPTION OF THE DRAWINGS

In order to better understand the characteristics and technical aspect of the invention, please refer to the following detailed description of the present invention is concerned with the diagrams, however, provide reference to the accompanying drawings and description only and is not intended to be limiting of the invention.

In drawings,

FIG. 1 is a diagram of a liquid crystal display panel having a dual gate structure according to prior art;

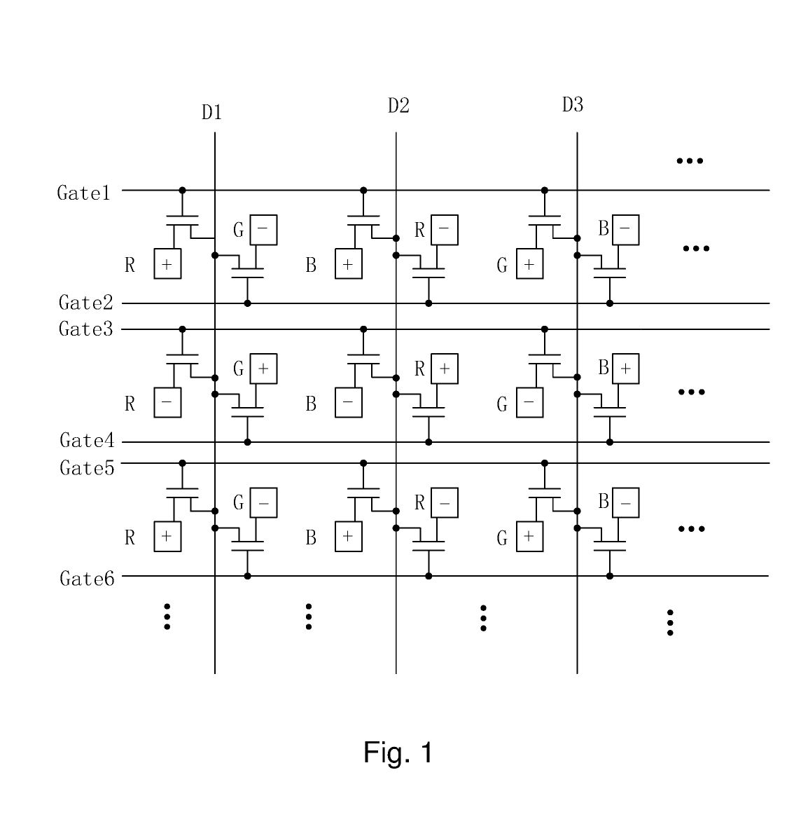

FIG. 2 is a drive sequence diagram of the liquid crystal display panel shown in FIG. 1;

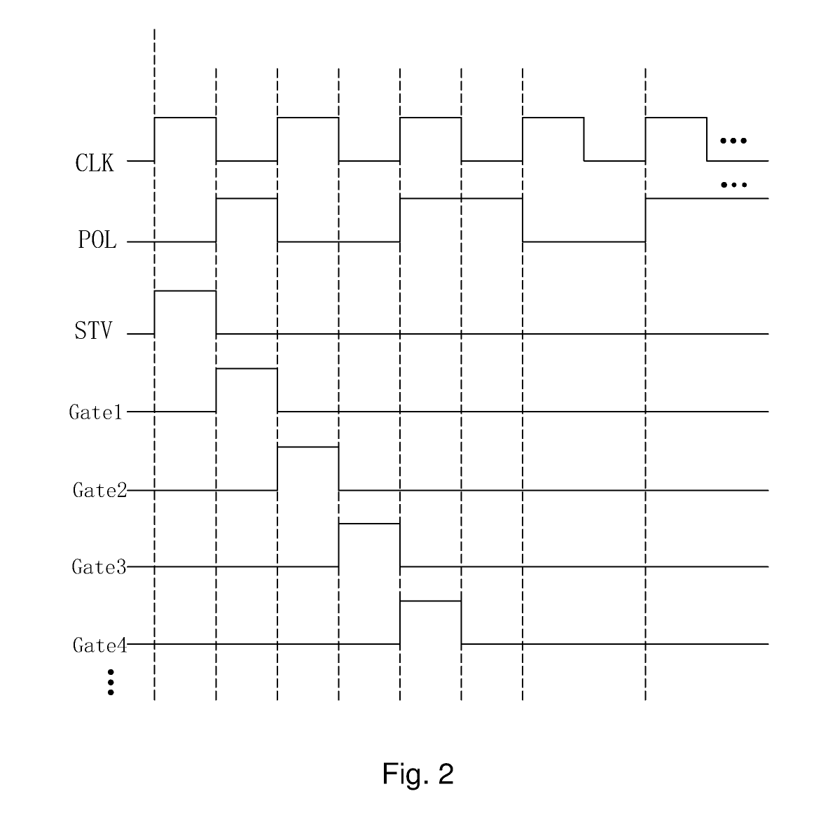

FIG. 3 is a structure diagram of a liquid crystal display panel of the present invention;

FIG. 4 is a drive sequence diagram of the liquid crystal display panel of the present invention;

FIG. 5 is a effect diagram that the liquid crystal display panel of the present invention shows a former frame of image;

FIG. 6 is a effect diagram that the liquid crystal display panel of the present invention shows a latter frame of image;

FIG. 7 is a flowchart of a drive method of a liquid crystal display panel according to the present invention.

### DETAILED DESCRIPTION OF PREFERRED EMBODIMENTS

For better explaining the technical solution and the effect of the present invention, the present invention will be further described in detail with the accompanying drawings and the specific embodiments.

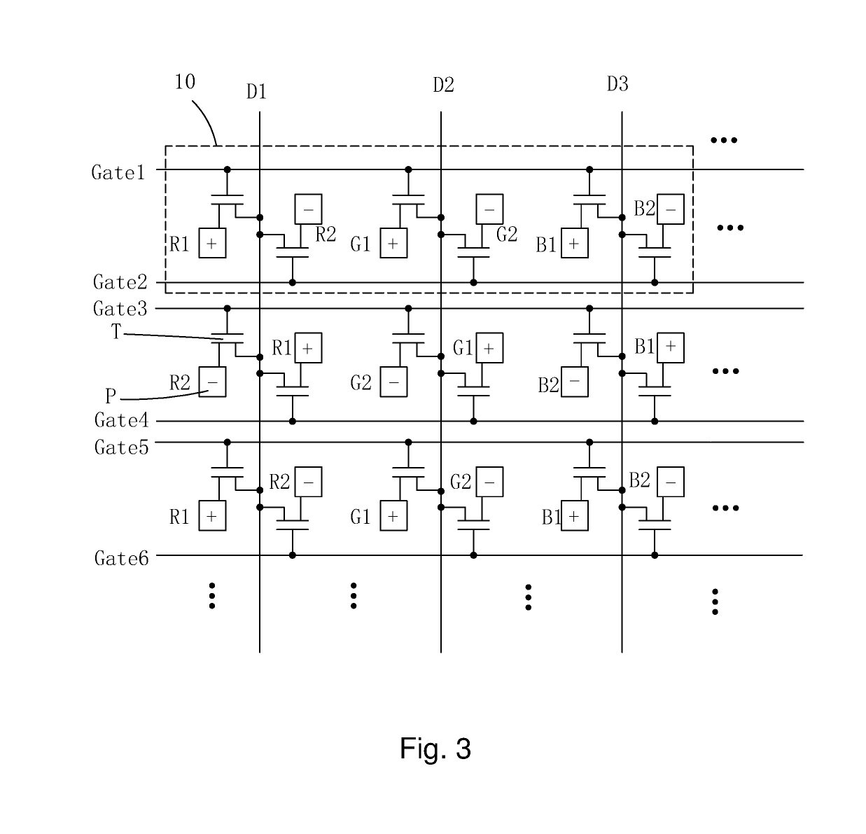

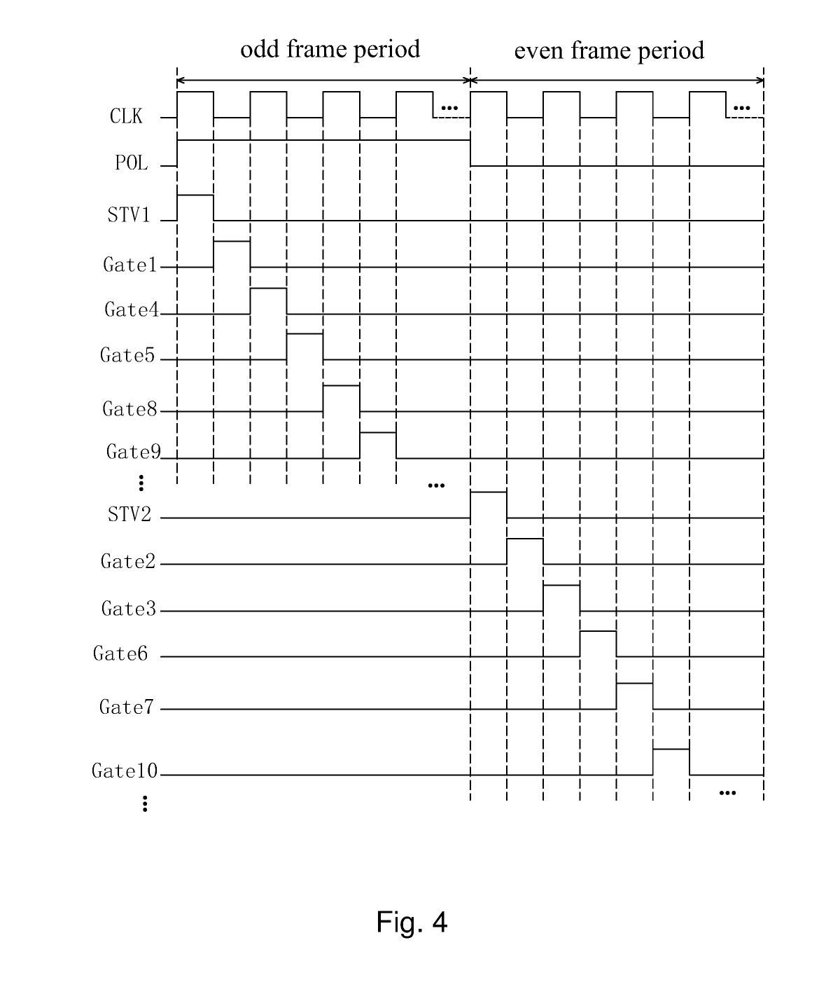

Please refer to FIG. 3 and FIG. 4, together. The present invention first provides a liquid crystal display panel, comprising: a plurality of data lines (such as D1, D2, D3), which are mutually parallel, sequentially aligned and vertical, a plurality of gate scan lines (such as Gate1, Gate2, Gate3, Gate4, Gate5, Gate6, Gate7), which are mutually parallel, sequentially aligned and horizontal and a plurality of pixel units 10 arranged in array.

Each pixel unit 10 comprises a red pixel module, a green pixel module and a blue pixel module which are sequentially repeated and aligned. The red pixel module comprises a first red sub pixel R1 and a second red sub pixel R2, and the green pixel module comprising a first green sub pixel G1 and a second green sub pixel G2, and the blue pixel module comprising a first blue sub pixel B1 and a second blue sub pixel B2. Specifically, as shown in FIG. 3, in the sub pixels of odd row, the respective sub pixels are sequentially repeated and aligned according to the order of the first red sub pixel R1, the second red sub pixel R2, the first green sub pixel G1, the second green sub pixel G2, the first blue sub pixel B1 and the second blue sub pixel B2; in the sub pixels of even row, the respective sub pixels are sequentially repeated and aligned according to the order of the second red sub pixel R2, the first red sub pixel R1, the second green sub pixel G2, the first green sub pixel G1, the second blue sub pixel B2 and the first blue sub pixel B1.

Furthermore, a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same; for instance, both the sub pixels of the first column and the second column are electrically coupled to the first data line D1, and the first red sub pixel R1, the second red sub pixel R2 in the sub pixels of the first column are sequentially and alternately aligned according to the order from top to bottom, and the second red sub pixel R2, the first red sub pixel R1 in the sub pixels of the second column are sequentially and alternately aligned according to the order from top to bottom, and both the sub pixels of the third column and the fourth column are electrically coupled to the second data line D2, and the first green sub pixel G1, the second green sub pixel G2 in the sub pixels of the third column are sequentially and alternately aligned according to the order from top to bottom, and the second green sub pixel G2, the first green sub pixel G1 in the sub pixels of the fourth column are sequentially and alternately aligned according to the order from top to bottom, and both the sub pixels of the fifth column and the sixth column are electrically coupled to the third data line D3, and the first blue sub pixel B1, the second blue sub pixel B2 in the sub pixels of the fifth column are sequentially and alternately aligned according to the order from top to bottom, and the second blue sub pixel B2, the first blue sub pixel B1 in the sub pixels of the sixth column are sequentially and alternately aligned according to the order from top to bottom, and so on. Gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are; for instance, the first gate scan line Gate 1 is located at the upper side of the sub pixels of the first row, and the second gate scan line Gate 2 is located at the lower side of the sub pixels of the first row, and the third gate scan line Gate 3 is located at the upper side of the sub pixels of the second row, and the fourth gate scan line Gate 4 is located at the lower side of the sub pixels of the second row, and the fifth gate scan line Gate 5 is located at the upper side of the sub pixels of the third row, and the sixth gate scan line Gate 6 is located at the lower side of the sub pixels of the third row, and so on.

Particularly, the first gate scan line to the last gate scan line are sequentially aligned from top to bottom, and j is set to be a positive integer, and both the 4jth gate scan line and the 4j−3 gate scan line, such as Gate1, Gate4, Gate5, Gate8, Gate9 are odd frame gate scan lines, and both the 4j−1th gate scan line and the 4j−2 gate scan line, such as Gate2, Gate3, Gate6, Gate7, Gate10 are even frame gate scan lines, and all the first red sub pixel R1, the first green sub pixel G1 and the first blue sub pixel B1 are electrically coupled to the odd frame gate scan line, and all the second red sub pixel R2, the second green sub pixel G2 and the second blue sub pixel B2 are electrically coupled to the even frame gate scan line. In mapping with FIG. 3, all the first red sub pixel R1, the first green sub pixel G1 and the first blue sub pixel B1 in the first row, the odd column are coupled to the first gate scan line Gate1, and all the second red sub pixel R2, the second green sub pixel G2 and the second blue sub pixel B12 in the first row, the even column are electrically coupled to the second frame gate scan line Gate2, and all the second red sub pixel R2, the second green sub pixel G2 and the second blue sub pixel B2 in the second row, the odd column are electrically coupled to the third frame gate scan line Gate3, and all the first red sub pixel R1, the first green sub pixel G1 and the first blue sub pixel B1 in the second row, the even column are coupled to the fourth gate scan line Gate4, and all the first red sub pixel R1, the first green sub pixel G1 and the first blue sub pixel B1 in the third row, the odd column are coupled to the fifth gate scan line Gate5, and all the second red sub pixel R2, the second green sub pixel G2 and the second blue sub pixel B2 in the third row, the even column are electrically coupled to the sixth frame gate scan line Gate6, and so on.

as driving the liquid crystal display panel, the odd frame scan lines first perform odd frame scan from top to bottom, and the odd frame scan is started by providing an odd frame scan trigger signal STV1 to the liquid crystal display panel; and after the odd frame scan is accomplished, the even frame scan lines perform even frame scan from top to bottom, and the even frame scan is started by providing an even frame scan trigger signal STV2 to the liquid crystal display panel.

As the odd frame scan or the even frame scan, polarities of data signals on the respective data lines are the same; the polarity of the data signal on the data line as the odd frame scan and polarity of the data signal on the data line as the even frame scan are opposite. The polarity change of the data signal is controlled by the inversion signal POL. For the former, latter two frames of images, the polarity of the inversion signal is inverted once to control the polarity of the data signal to be inverted once. Namely, the period of the inversion signal POL is twice of the period of one frame of image. The frequency of the inversion signal POL is ½ of the frame frequency of the liquid crystal display panel. One period of one frame of image comprises a plurality of periods of clock signals CLK. Therefore, on the basis of achieving the dot inversion effect according to the liquid crystal display panel of the present invention, the inversion frequency of the positive, negative polarities of the data signal is tremendously reduced in comparison with prior art. It can effectively weaken the data signal delay to ensure the charge results of the respective sub pixels for eliminating the bright fringes in the display procedure of the liquid crystal display panel having the dual gate structure and for reducing the drive power consumption of the liquid crystal display panel.

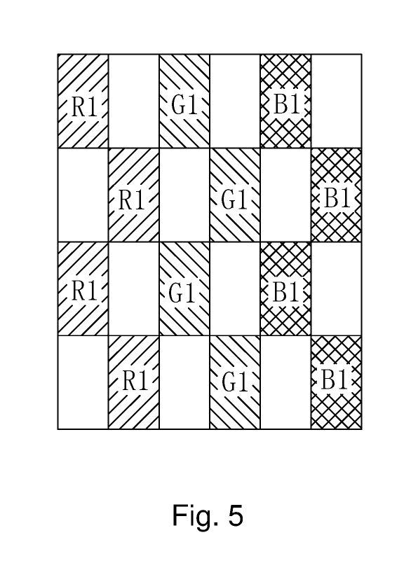

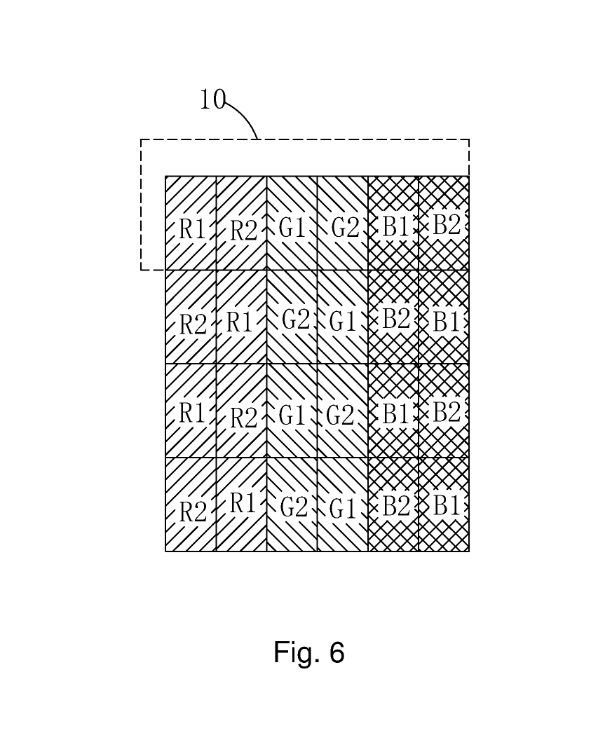

Selectably, as the odd frame scan, the inversion signal POL controls the polarities of the data signals on the respective data lines to be positive. As shown in FIG. 5, all the first red sub pixel R1, the first green sub pixel G1 and the first blue sub pixel B1 are positive for displaying; as the even frame scan, the inversion signal POL controls the polarities of the data signals on the respective data lines to be negative. As shown in FIG. 6, all the second red sub pixel R2, the second green sub pixel G2 and the second blue sub pixel B2 are positive for displaying.

Certainly, as the odd frame scan, the inversion signal POL also can control the polarities of the data signals on the respective data lines to be negative; as the even frame scan, the inversion signal POL also can control the polarities of the data signals on the respective data lines to be positive.

Furthermore, each sub pixel comprises a thin film transistor T, and a pixel electrode P electrically coupled to the thin film transistor T; a gate of the thin film transistor T is electrically coupled to the gate scan line corresponded with the sub pixel, and a source is electrically coupled to a data line corresponded with the sub pixel, and a drain is electrically coupled to the pixel electrode P.

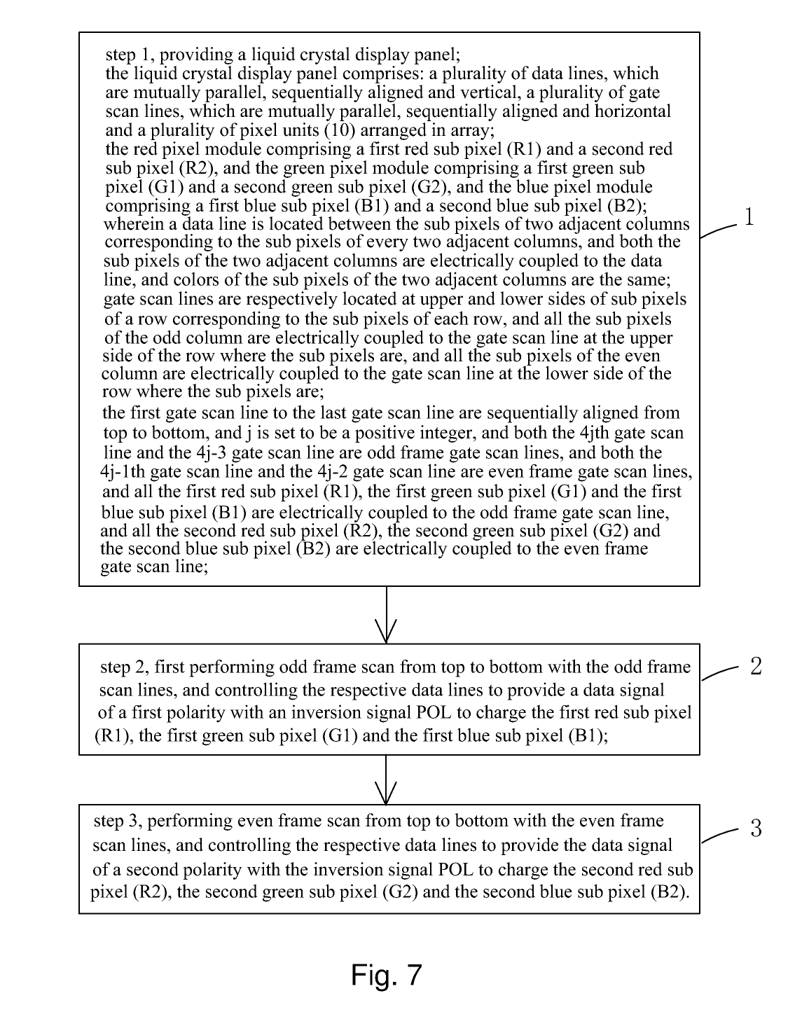

Please refer to FIG. 7 with combination of FIG. 3 and FIG. 4. The present invention further provides a drive method of a liquid crystal display panel, comprising steps of:

step 1, providing a liquid crystal display panel.

Please refer to FIG. 3 and FIG. 4, together. The liquid crystal display panel comprises: a plurality of data lines (such as D1, D2, D3), which are mutually parallel, sequentially aligned and vertical, a plurality of gate scan lines (such as Gate1, Gate2, Gate3, Gate4, Gate5, Gate6, Gate7), which are mutually parallel, sequentially aligned and horizontal and a plurality of pixel units 10 arranged in array.

Each pixel unit 10 comprises a red pixel module, a green pixel module and a blue pixel module which are sequentially repeated and aligned. The red pixel module comprises a first red sub pixel R1 and a second red sub pixel R2, and the green pixel module comprising a first green sub pixel G1 and a second green sub pixel G2, and the blue pixel module comprising a first blue sub pixel B1 and a second blue sub pixel B2. Specifically, as shown in FIG. 3, in the sub pixels of odd row, the respective sub pixels are sequentially repeated and aligned according to the order of the first red sub pixel R1, the second red sub pixel R2, the first green sub pixel G1, the second green sub pixel G2, the first blue sub pixel B1 and the second blue sub pixel B2; in the sub pixels of even row, the respective sub pixels are sequentially repeated and aligned according to the order of the second red sub pixel R2, the first red sub pixel R1, the second green sub pixel G2, the first green sub pixel G1, the second blue sub pixel B2 and the first blue sub pixel B1.

Furthermore, a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same; for instance, both the sub pixels of the first column and the second column are electrically coupled to the first data line D1, and the first red sub pixel R1, the second red sub pixel R2 in the sub pixels of the first column are sequentially and alternately aligned according to the order from top to bottom, and the second red sub pixel R2, the first red sub pixel R1 in the sub pixels of the second column are sequentially and alternately aligned according to the order from top to bottom, and both the sub pixels of the third column and the fourth column are electrically coupled to the second data line D2, and the first green sub pixel G1, the second green sub pixel G2 in the sub pixels of the third column are sequentially and alternately aligned according to the order from top to bottom, and the second green sub pixel G2, the first green sub pixel G1 in the sub pixels of the fourth column are sequentially and alternately aligned according to the order from top to bottom, and both the sub pixels of the fifth column and the sixth column are electrically coupled to the third data line D3, and the first blue sub pixel B1, the second blue sub pixel B2 in the sub pixels of the fifth column are sequentially and alternately aligned according to the order from top to bottom, and the second blue sub pixel B2, the first blue sub pixel B1 in the sub pixels of the sixth column are sequentially and alternately aligned according to the order from top to bottom, and so on. Gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are; for instance, the first gate scan line Gate 1 is located at the upper side of the sub pixels of the first row, and the second gate scan line Gate 2 is located at the lower side of the sub pixels of the first row, and the third gate scan line Gate 3 is located at the upper side of the sub pixels of the second row, and the fourth gate scan line Gate 4 is located at the lower side of the sub pixels of the second row, and the fifth gate scan line Gate 5 is located at the upper side of the sub pixels of the third row, and the sixth gate scan line Gate 6 is located at the lower side of the sub pixels of the third row, and so on.

Particularly, the first gate scan line to the last gate scan line are sequentially aligned from top to bottom, and j is set to be a positive integer, and both the 4jth gate scan line and the 4j−3 gate scan line, such as Gate1, Gate4, Gate5, Gate8, Gate9 are odd frame gate scan lines, and both the 4j−1th gate scan line and the 4j−2 gate scan line, such as Gate2, Gate3, Gate6, Gate7, Gate10 are even frame gate scan lines, and all the first red sub pixel R1, the first green sub pixel G1 and the first blue sub pixel B1 are electrically coupled to the odd frame gate scan line, and all the second red sub pixel R2, the second green sub pixel G2 and the second blue sub pixel B2 are electrically coupled to the even frame gate scan line. In mapping with FIG. 3, all the first red sub pixel R1, the first green sub pixel G1 and the first blue sub pixel B1 in the first row, the odd column are coupled to the first gate scan line Gate1, and all the second red sub pixel R2, the second green sub pixel G2 and the second blue sub pixel B12 in the first row, the even column are electrically coupled to the second frame gate scan line Gate2, and all the second red sub pixel R2, the second green sub pixel G2 and the second blue sub pixel B2 in the second row, the odd column are electrically coupled to the third frame gate scan line Gate3, and all the first red sub pixel R1, the first green sub pixel G1 and the first blue sub pixel B1 in the second row, the even column are coupled to the fourth gate scan line Gate4, and all the first red sub pixel R1, the first green sub pixel G1 and the first blue sub pixel B1 in the third row, the odd column are coupled to the fifth gate scan line Gate5, and all the second red sub pixel R2, the second green sub pixel G2 and the second blue sub pixel B2 in the third row, the even column are electrically coupled to the sixth frame gate scan line Gate6, and so on.

Furthermore, each sub pixel comprises a thin film transistor T, and a pixel electrode P electrically coupled to the thin film transistor T; a gate of the thin film transistor T is electrically coupled to the gate scan line corresponded with the sub pixel, and a source is electrically coupled to a data line corresponded with the sub pixel, and a drain is electrically coupled to the pixel electrode P.

step 2, first performing odd frame scan from top to bottom with the odd frame scan lines, and controlling the respective data lines to provide a data signal of a first polarity with an inversion signal POL to charge the first red sub pixel R1, the first green sub pixel G1 and the first blue sub pixel B1.

step 3, performing even frame scan from top to bottom with the even frame scan lines, and controlling the respective data lines to provide the data signal of a second polarity with the inversion signal POL to charge the second red sub pixel R2, the second green sub pixel G2 and the second blue sub pixel B2.

Specifically, a frequency of the inversion signal POL is ½ of a frame frequency of the liquid crystal display panel. In the step 2, the odd frame scan is started by providing an odd frame scan trigger signal STV1 to the liquid crystal display panel. In the step 3, the even frame scan is started by providing an even frame scan trigger signal STV2 to the liquid crystal display panel.

Selectably, the first polarity is positive, and the second polarity is negative, or the first polarity is negative, and the second polarity is positive.

The polarity change of the data signal is controlled by the inversion signal POL in the drive method of the liquid crystal display panel according to the present invention. For the former, latter two frames of images, the polarity of the inversion signal is inverted once to control the polarity of the data signal to be inverted once. Namely, the period of the inversion signal POL is twice of the period of one frame of image. The frequency of the inversion signal POL is ½ of the frame frequency of the liquid crystal display panel. One period of one frame of image comprises a plurality of periods of clock signals CLK. Therefore, on the basis of achieving the dot inversion effect according to the drive method of the liquid crystal display panel of the present invention, the inversion frequency of the positive, negative polarities of the data signal is tremendously reduced in comparison with prior art. It can effectively weaken the data signal delay to ensure the charge results of the respective sub pixels for eliminating the bright fringes in the display procedure of the liquid crystal display panel having the dual gate structure and for reducing the drive power consumption of the liquid crystal display panel.

In conclusion, the present invention provides a liquid crystal display panel and a drive method thereof. Each pixel unit is set to comprise a red pixel module, a green pixel module and a blue pixel module which are sequentially repeated and aligned. The red pixel module comprises a first red sub pixel and a second red sub pixel, and the green pixel module comprises a first green sub pixel and a second green sub pixel, and the blue pixel module comprises a first blue sub pixel and a second blue sub pixel. Both the 4jth gate scan line and the 4j−3 gate scan line are set to be odd frame gate scan lines, and both the 4j−1th gate scan line and the 4j−2 gate scan line are set to be even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line, and the odd frame gate scan lines and the even frame gate scan lines respectively perform the odd frame scan and the even frame scan. The data lines drive the first red sub pixel, the first green sub pixel and the first blue sub pixel as the odd frame scan, and drive the second red sub pixel, the second green sub pixel and the second blue sub pixel as the even frame scan so that the frequency of the inversion signal is decreased to be ½ of the frame frequency of the liquid crystal display panel. In comparison with prior art, the inversion frequency of the positive, negative polarities of the data signal is tremendously reduced. It can effectively weaken the data signal delay to ensure the charge results of the respective sub pixels for eliminating the bright fringes in the display procedure of the liquid crystal display panel having the dual gate structure and for reducing the drive power consumption of the liquid crystal display panel.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A liquid crystal display panel, comprising: a plurality of data lines, which are mutually parallel, sequentially aligned and vertical, a plurality of gate scan lines, which are mutually parallel, sequentially aligned and horizontal and a plurality of pixel units arranged in array;
each pixel unit comprising a red pixel module, a green pixel module and a blue pixel module which are sequentially repeated and aligned;
the red pixel module comprising a first red sub pixel and a second red sub pixel, and the green pixel module comprising a first green sub pixel and a second green sub pixel, and the blue pixel module comprising a first blue sub pixel and a second blue sub pixel;
wherein a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same;
gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are;
the first gate scan line to the last gate scan line are sequentially aligned from top to bottom, and j is set to be a positive integer, and both the 4jth gate scan line and the 4j−3 gate scan line are odd frame gate scan lines, and both the 4j−1th gate scan line and the 4j−2 gate scan line are even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line;
as driving the liquid crystal display panel, the odd frame scan lines first perform odd frame scan from top to bottom, and after the odd frame scan is accomplished, the even frame scan lines perform even frame scan from top to bottom;
as the odd frame scan or the even frame scan, polarities of data signals on the respective data lines are the same; the polarity of the data signal on the data line as the odd frame scan and polarity of the data signal on the data line as the even frame scan are opposite.

2. The liquid crystal display panel according to claim 1, wherein as the odd frame scan, an inversion signal controls the polarities of the data signals on the respective data lines to be positive, and as the even frame scan, the inversion signal controls the polarities of the data signals on the respective data lines to be negative.

3. The liquid crystal display panel according to claim 1, wherein as the odd frame scan, an inversion signal controls the polarities of the data signals on the respective data lines to be negative, and as the even frame scan, the inversion signal controls the polarities of the data signals on the respective data lines to be positive.

4. The liquid crystal display panel according to claim 1, wherein each sub pixel comprises a thin film transistor, and a pixel electrode electrically coupled to the thin film transistor; a gate of the thin film transistor is electrically coupled to the gate scan line corresponded with the sub pixel, and a source is electrically coupled to a data line corresponded with the sub pixel, and a drain is electrically coupled to the pixel electrode.

5. A drive method of a liquid crystal display panel, comprising steps of:
step 1, providing a liquid crystal display panel;
the liquid crystal display panel comprising: a plurality of data lines, which are mutually parallel, sequentially aligned and vertical, a plurality of gate scan lines, which are mutually parallel, sequentially aligned and horizontal and a plurality of pixel units arranged in array;
each pixel unit comprising a red pixel module, a green pixel module and a blue pixel module which are sequentially repeated and aligned;
the red pixel module comprising a first red sub pixel and a second red sub pixel, and the green pixel module comprising a first green sub pixel and a second green sub pixel, and the blue pixel module comprising a first blue sub pixel and a second blue sub pixel;
wherein a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same;
gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are;
the first gate scan line to the last gate scan line are sequentially aligned from top to bottom, and j is set to be a positive integer, and both the 4jth gate scan line and the 4j−3 gate scan line are odd frame gate scan lines, and both the 4j−1th gate scan line and the 4j−2 gate scan line are even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line;
step 2, first performing odd frame scan from top to bottom with the odd frame scan lines, and controlling the respective data lines to provide a data signal of a first polarity with an inversion signal to charge the first red sub pixel, the first green sub pixel and the first blue sub pixel;
step 3, performing even frame scan from top to bottom with the even frame scan lines, and controlling the respective data lines to provide the data signal of a second polarity with the inversion signal to charge the second red sub pixel, the second green sub pixel and the second blue sub pixel.

6. The drive method of the liquid crystal display panel according to claim 5, wherein a frequency of the inversion signal is ½ of a frame frequency of the liquid crystal display panel.

7. The drive method of the liquid crystal display panel according to claim 5, wherein the first polarity is positive, and the second polarity is negative.

8. The drive method of the liquid crystal display panel according to claim 5, wherein the first polarity is negative, and the second polarity is positive.

9. The drive method of the liquid crystal display panel according to claim 5, wherein in the step 2, the odd frame scan is started by providing an odd frame scan trigger signal to the liquid crystal display panel;
in the step 3, the even frame scan is started by providing an even frame scan trigger signal to the liquid crystal display panel.

10. The drive method of the liquid crystal display panel according to claim 5, wherein each sub pixel comprises a thin film transistor, and a pixel electrode electrically coupled to the thin film transistor; a gate of the thin film transistor is electrically coupled to the gate scan line corresponded with the sub pixel, and a source is electrically coupled to a data line corresponded with the sub pixel, and a drain is electrically coupled to the pixel electrode.

11. A drive method of a liquid crystal display panel, comprising steps of:
step 1, providing a liquid crystal display panel;
the liquid crystal display panel comprising: a plurality of data lines, which are mutually parallel, sequentially aligned and vertical, a plurality of gate scan lines, which are mutually parallel, sequentially aligned and horizontal and a plurality of pixel units arranged in array;
each pixel unit comprising a red pixel module, a green pixel module and a blue pixel module which are sequentially repeated and aligned;
the red pixel module comprising a first red sub pixel and a second red sub pixel, and the green pixel module comprising a first green sub pixel and a second green sub pixel, and the blue pixel module comprising a first blue sub pixel and a second blue sub pixel;
wherein a data line is located between the sub pixels of two adjacent columns corresponding to the sub pixels of every two adjacent columns, and both the sub pixels of the two adjacent columns are electrically coupled to the data line, and colors of the sub pixels of the two adjacent columns are the same;
gate scan lines are respectively located at upper and lower sides of sub pixels of a row corresponding to the sub pixels of each row, and all the sub pixels of the odd column are electrically coupled to the gate scan line at the upper side of the row where the sub pixels are, and all the sub pixels of the even column are electrically coupled to the gate scan line at the lower side of the row where the sub pixels are;
the first gate scan line to the last gate scan line are sequentially aligned from top to bottom, and j is set to be a positive integer, and both the 4jth gate scan line and the 4j−3 gate scan line are odd frame gate scan lines, and both the 4j−1th gate scan line and the 4j−2 gate scan line are even frame gate scan lines, and all the first red sub pixel, the first green sub pixel and the first blue sub pixel are electrically coupled to the odd frame gate scan line, and all the second red sub pixel, the second green sub pixel and the second blue sub pixel are electrically coupled to the even frame gate scan line;
step 2, first performing odd frame scan from top to bottom with the odd frame scan lines, and controlling the respective data lines to provide a data signal of a first polarity with an inversion signal to charge the first red sub pixel, the first green sub pixel and the first blue sub pixel;
step 3, performing even frame scan from top to bottom with the even frame scan lines, and controlling the respective data lines to provide the data signal of a second polarity with the inversion signal to charge the second red sub pixel, the second green sub pixel and the second blue sub pixel;
wherein each sub pixel comprises a thin film transistor, and a pixel electrode electrically coupled to the thin film transistor; a gate of the thin film transistor is electrically coupled to the gate scan line corresponded with the sub pixel, and a source is electrically coupled to a data line corresponded with the sub pixel, and a drain is electrically coupled to the pixel electrode;
wherein a frequency of the inversion signal is ½ of a frame frequency of the liquid crystal display panel.

12. The drive method of the liquid crystal display panel according to claim 11, wherein the first polarity is positive, and the second polarity is negative.

13. The drive method of the liquid crystal display panel according to claim 11, wherein the first polarity is negative, and the second polarity is positive.

14. The drive method of the liquid crystal display panel according to claim 11, wherein in the step 2, the odd frame scan is started by providing an odd frame scan trigger signal to the liquid crystal display panel;
in the step 3, the even frame scan is started by providing an even frame scan trigger signal to the liquid crystal display panel.
